(19) United States
(12) Patent Application Publication
(10) Pub. No.: US 2013/0238675 A1
(43) Pub. Date: Sep. 12, 2013

(54) INFORMATION PROCESSING APPARATUS, IMAGE FILE MANAGEMENT METHOD AND STORAGE MEDIUM

(71) Applicants: Munehisa Tomioka, Hino-shi (JP); Yuji Fujiwara, Hamura-shi (JP); Hiroshi Nakajima, Nishitokyo-shi (JP)

(72) Inventors: Munehisa Tomioka, Hino-shi (JP); Yuji Fujiwara, Hamura-shi (JP); Hiroshi Nakajima, Nishitokyo-shi (JP)

(21) Appl. No.: 13/615,032

(22) Filed: Sep. 13, 2012

(30) Foreign Application Priority Data
Mar. 8, 2012 (JP) 2012-052174

(51) Int. Cl. G06F 17/30

(52) U.S. Cl. 707/827; 707/E17.01

(57) ABSTRACT

According to one embodiment, an information processing apparatus applied to a client management system managing desktop environments of client terminals comprises a first controller and a second controller. The first controller controls creation processing for first image files which are disk image files for the desktop environments and contain no information unique to the client terminals and difference files for formation of second image files respectively containing information unique to the client terminals based on the first image files. The second controller controls deletion processing for the difference file for which the second image file is completely acquired by a corresponding client terminal.

### CROSS-REFERENCE TO RELATED APPLICATIONS

This application is based upon and claims the benefit of priority from Japanese Patent Application No. 2012-052174, filed Mar. 8, 2012, the entire contents of which are incorporated herein by reference.

### FIELD

Embodiments described herein relate generally to an information processing apparatus, an image file management method and a storage medium for managing the desktop environments of a plurality of client terminals.

### BACKGROUND

In recent years, various kinds of companies are now considering introducing systems (client management systems) for managing many client terminals in offices by using servers.

A client management system can perform centralized management of the desktop environments (an operating system [OS] and application programs) of many client terminals by using a server in the client management system. Desktop environments are managed, for example, as virtual image files containing an OS and application programs, which are disk image files such as virtual hard disk (VHD) format files.

An increase in the number of client terminals to be managed by a server will increase the number of desktop environments to be managed in a centralized manner by the server. Since the resources of a server, such as disks storing desktop environments of client terminals, are finite, a large increase in the number of client terminals will require a mechanism for efficiently managing the desktop environments of the client terminals.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram showing the arrangement of a client management system to which an information processing apparatus (management server) of an embodiment is applied.

FIG. 2 is an exemplary block diagram for explaining an example of a communication procedure between the client management system and the rich client terminals (virtual client terminals) in FIG. 1.

FIG. 3 is an exemplary block diagram for explaining an example of a communication procedure between the client management system and the thin client terminals in FIG. 1.

FIG. 4 is an exemplary view for explaining the roaming function provided by a connection broker applied to the client management system in FIG. 1.

FIG. 5 is an exemplary view for explaining the user profiles managed by the connection broker applied to the client management system in FIG. 1.

FIG. 6 is an exemplary block diagram for explaining a linkage for handling virtual image files in the client management system in FIG. 1.

FIG. 7 is an exemplary view for explaining the structure of the virtual image files created by a virtual image creation and distribution server applied to the client management system in FIG. 1.

FIG. 8 is an exemplary sequence chart associated with the handling of virtual image files in the client management system in FIG. 1.

FIG. 9 is an exemplary sequence chart for deletion processing of a virtual image file including an individual image file (difference file) controlled by a management server applied to the client management system in FIG. 1.

FIG. 10 is an exemplary view showing one form in a case wherein two virtual image creation and distribution servers perform decentralized management of virtual image files in the client management system in FIG. 1.

FIG. 11 is an exemplary view for explaining the first principle based on which a management server applied to the client management system in FIG. 1 decides the assignment destinations of virtual image files.

FIG. 12A is an exemplary first view for explaining the second principle based on which the management server applied to the client management system in FIG. 1 decides the assignment destinations of virtual image files.

FIG. 12B is an exemplary second view for explaining the second principle based on which the management server applied to the client management system in FIG. 1 decides the assignment destinations of virtual image files.

FIG. 13 is an exemplary view showing operation associated with the updating of a virtual image file in the client management system in FIG. 1.

### DETAILED DESCRIPTION

Various embodiments will be described hereinafter with reference to the accompanying drawings.

In general, according to one embodiment, an information processing apparatus is applied to a client management system which manages desktop environments of a plurality of client terminals. The apparatus comprises a first controller and a second controller. The first controller is configured to control creation processing for first image files and difference files. The first image files are disk image files for the desktop environments and contain no information unique to the plurality of client terminals. The difference files are files for formation of second image files respectively containing information unique to the plurality of client terminals based on the first image files. The second controller is configured to control deletion processing for the difference file for which the second image file is completely acquired by a corresponding client terminal of the plurality of client terminals.

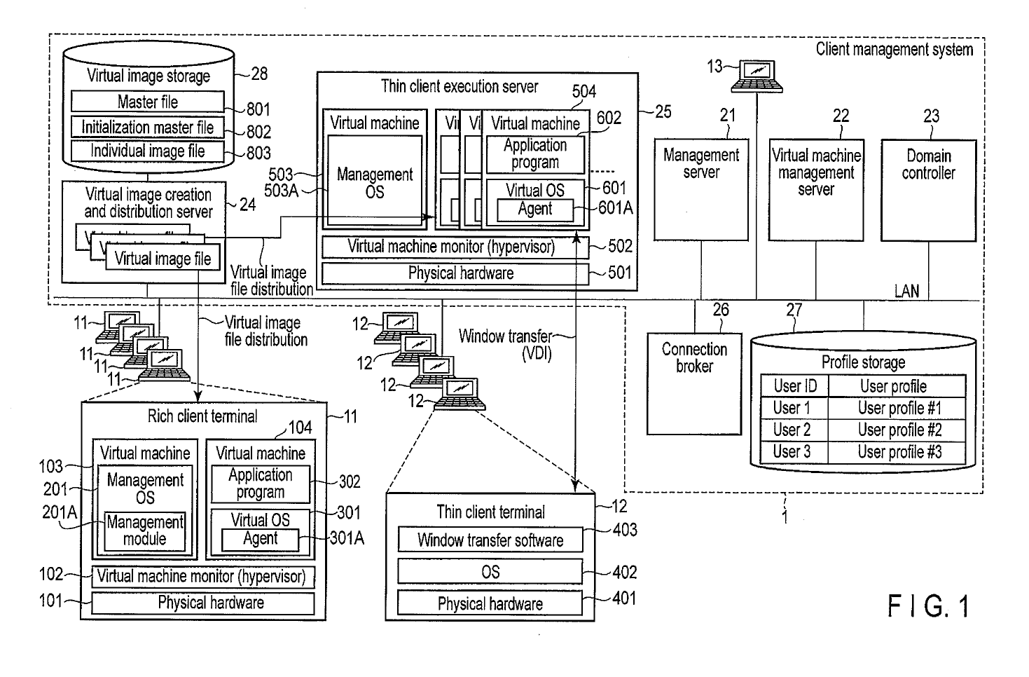

FIG. 1 shows the arrangement of a client management system 1 to which the information processing apparatus (management server 21) of this embodiment is applied. The client management system 1 is a server system for managing a plurality of client terminals. The client management system 1 can be implemented by one or more servers (physical servers). Assume that the client management system 1 is implemented by a plurality of servers.

As shown in FIG. 1, the client management system 1 includes the management server 21, a virtual machine management server 22, a domain controller 23, a virtual image creation and distribution server 24, a thin client execution server 25, a connection broker 26, a profile storage 27, and a virtual image storage 28.

The management server 21, the virtual machine management server 22, the domain controller 23, the virtual image creation and distribution server 24, the thin client execution server 25, the connection broker 26 and the profile storage 27 are connected to a network such as a local area network (LAN). First-type client terminals 11, second-type client terminals 12 and a manager terminal 13 are also connected to this network.

The client management system 1 is built up in, for example, an office environment. The client management system 1 performs centralized management of a plurality of client terminals arranged in the office by using the management server 21. The client management system 1 also stores, in the profile storage 27, a plurality of user files applied to a plurality of client terminals. Each user profile contains setting information for setting a user environment for the client terminal to which the user profile is applied. The setting information includes, for example, various kinds of setting information associated with application programs and various kinds of setting information associated with desktop windows. Each user profile also contains user data such as a document file created by the user using an application program.

The client management system 1 of this embodiment can manage two types of client terminals, namely first-type client terminals and second-type client terminals. The client terminals 11 shown in FIG. 1 are first-type client terminals. A first-type client terminal is a so-called virtualization client terminal. A virtual machine monitor (hypervisor) is installed as virtualization software in the local storage of a first-type client terminal. A first-type client terminal executes this virtualization software and the OS and application programs in the virtual image file distributed from the client management system 1.

That is, a first-type client terminal (to be referred to as the rich client terminal 11 hereinafter) executes a virtual machine monitor 102 on physical hardware 101 such as a CPU, memory, storage, and various kinds of I/O devices. The virtual machine monitor 102 is virtualization software such as a hypervisor, which functions as a virtualization layer on the physical hardware 101 by emulating the resources of the physical hardware 101. Several virtual machines are executed on the virtual machine monitor 102 as a virtualization layer. FIG. 1 assumes a case in which two virtual machines 103 and 104 are executed on the virtual machine monitor 102. The virtual machine 103 is a virtual machine for executing a management OS (host OS) 201. In contrast, the virtual machine 104 executes a virtual OS (guest OS) 301 and application program 302 in the virtual image file distributed from the client management system 1. The virtual machine 104, i.e., the virtual OS (guest OS) 301 and the application program 302, operates as a desktop environment of the rich client terminal 11.

The management OS (host OS) 201 can control the virtual machine 104 in cooperation with the virtual machine monitor 102. The management OS (host OS) 201 includes a management module 201A. The management module 201A can download a virtual image file from the virtual image creation and distribution server 24 of the client management system 1. The virtual OS (guest OS) 301 includes an agent 301A. The agent 301A is a program which executes the processing of linking the client management system 1 to the rich client terminal 11.

Second-type client terminals are thin client terminals. These thin client terminals 12 respectively communicate with virtual machines 504, executed on the thin client execution server 25 of the client management system 1, by using a window transfer protocol. In other words, a plurality of thin client terminals 12 are terminals (base terminals) for implementing desktop virtualization by using a virtual desktop infrastructure (VDT). The thin client execution server 25 serving as a virtualization server unifies the management of the desktop environments (OSs and application programs) of the thin client terminals 12. Each thin client terminal 12 is assigned with one of the virtual machines 504 on the thin client execution server 25. The virtual machines 504 on the thin client execution server 25, instead of on the thin client terminal 12, executes the OS and application programs.

Each thin client terminal 12 transmits input information corresponding to the operation of an input device (for example, a keyboard or mouse) by the user to the corresponding virtual machine 504 in the thin client execution server 25. Each thin client terminal 12 receives window information reflecting input information from the corresponding virtual machines 504 in the thin client execution server 25.

That is, the thin client terminal 12 executes window transfer software 403. The window transfer software 403 is a program which communicates with the virtual machine 504 in the thin client execution server 25 by using a window transfer protocol. The window transfer software 403 may be an application program which operates on the OS. In this case, the thin client terminal 12 executes an OS 402 on physical hardware 401 such as a CPU, memory, and various kinds of I/O devices, and executes the window transfer software 403 on the OS 402.

Each component of the client management system 1 will be described next.

The management server 21 is an information processing apparatus of this embodiment, and serves as a server for managing the operation of the client management system 1. The management server 21 can execute the management of each user who can use the client management system 1, the management of a virtual image file corresponding to each rich client terminal 11, and the like in accordance with the operation of the manager terminal 13 connected to a network, for example, a LAN. The information processing apparatus of this embodiment, i.e., the management server 21, has a mechanism for efficiently managing this virtual image file. This point will be described in detail below.

The virtual machine management server 22 is a server for managing the thin client execution server 25. The domain controller 23 is a server for authenticating each user and each client terminal. The virtual image creation and distribution server 24 functions as a distribution server which distributes virtual image files respectively containing OSs and application programs to the plurality of rich client terminals 11. The virtual image creation and distribution server 24 can also create virtual image files for the thin client terminals 12 as well as virtual image files for the rich client terminals 11. The virtual image files for the rich client terminals 11 are distributed to the respective rich client terminals 11. In contrast, the virtual image files for the thin client terminals 12 are distributed to the thin client execution server 25. Each virtual image file is a disk image file such as, for example, a VHD (Virtual Hardware Disk) format file. The disk image file is constituted by a master file 801, and an initialization master file 802 and an individual image file 803 serving as a difference file, which will be described later.

The thin client execution server 25 is a server which executes a plurality of virtual machines for communicating with the plurality of thin client terminals 12 by using a window transfer protocol. The thin client execution server 25 may be implemented by, for example, one physical server virtualized by a server virtualization technique.

The thin client execution server 25 executes a virtual machine monitor 502 on physical hardware 501 such as a CPU, memory, storage, and various kinds of I/O devices. The virtual machine monitor 502 is virtualization software such as a hypervisor, which functions as a virtualization layer on the physical hardware 501 by emulating the resources of the physical hardware 501. One virtual machine 503 for management and the plurality of virtual machines 504 for executing virtual desktop environments are executed on the virtual machine monitor 502. The virtual machine 503 executes a management OS (host OS) 503A. In contrast, each virtual machine 504 executes a virtual OS (guest OS) 601 and application program 602 in the virtual image file distributed from the virtual image creation and distribution server 24.

The management OS (host OS) 503A can control each virtual machine 504 in cooperation with the virtual machine monitor 502. The virtual OS (guest OS) 601 includes an agent 601A. Like the agent 301A in the virtual machine 104 of the rich client terminal 11, the agent 601A is a program which executes the processing of linking the client management system 1 to each thin client terminal 12.

The connection broker 26 is a server which is applied to the client management system 1 to, for example, manage user profiles. The connection broker 26 can be implemented by one physical server.

The connection broker 26 manages a plurality of user profiles by using the profile storage 27 storing a plurality of user profiles respectively corresponding to a plurality of users. The connection broker 26 also includes a function for assigning usable virtual machines on the thin client execution server 25 to users who have executed log-on operation on the thin client terminals 12. Furthermore, the connection broker 26 includes a function (roaming function) of allowing users to use the same user environment regardless of the client terminals on which the respective users perform log-on operation.

The profile storage 27 stores many user profiles respectively associated with the identifiers (user IDs) of many users which can use the client management system 1. That is, the profile storage 27 includes many storage locations for storing user profiles respectively corresponding to many users. When a given user performs log-on operation for connecting (logging on) a client terminal to the client management system 1, a user profile associated with the user ID of the user is automatically mounted in the file system of the virtual machine corresponding to the client terminal. In log-on processing for the rich client terminal 11, a user profile corresponding to the user who has performed log-on operation is mounted on the file system of the virtual machine 104 in the rich client terminal 11. The entity of a user profile (setting information and user data) does not exist in the local storage in the rich client terminal 11. The entity of each user profile is managed in the client management system 1. This can therefore enhance the security of the rich client terminal 11.

In log-on processing for the thin client terminal 12, a user profile associated with the user ID of a user who has performed log-on operation is automatically mounted on the file system of the virtual machine 504 in the thin client execution server 25 corresponding to the thin client terminal 12.

This allows each user to use the same user environment (the same user profile) regardless of the rich client terminal 11 or the thin client terminal 12 operated by the user to log-on to the client management system 1.

The virtual image storage 28 is storage for storing the virtual image file created by the virtual image creation and distribution server 24, i.e., the master file 801, the initialization master file 802, and the individual image file 803.

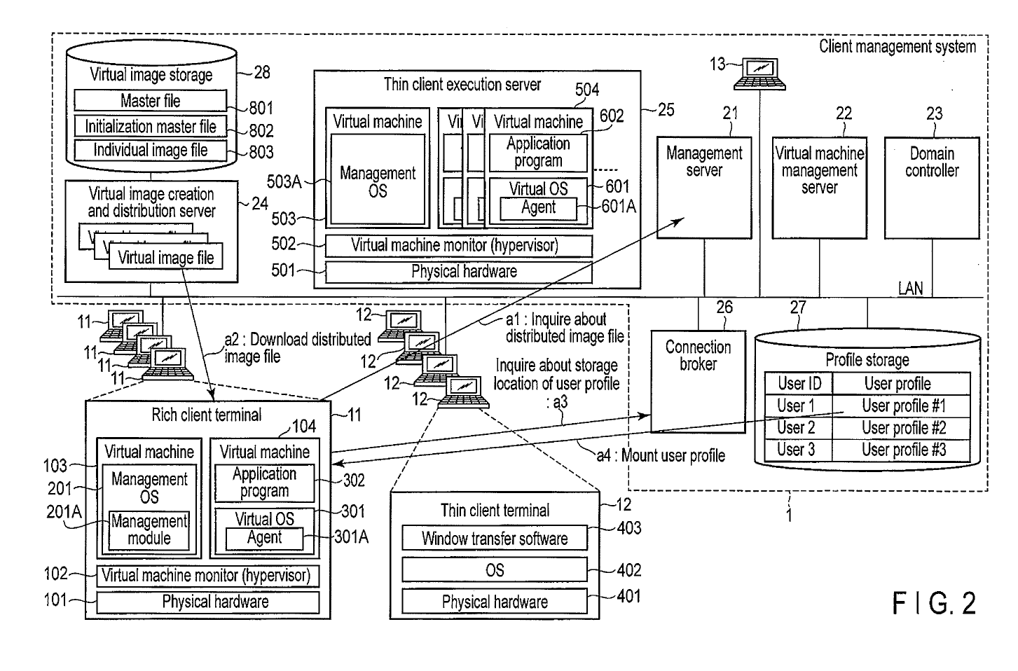

The operation sequence of the rich client terminal 11 will be described below with reference to FIG. 2.

a1: The management module 201A or agent 301A in the rich client terminal 11 inquires the management server 21 about whether there is any distribution image (virtual image file) to be applied to the rich client terminal 11. If, for example, there is no virtual image file in the local storage of the rich client terminal 11, or there is an updated virtual image file corresponding to a virtual image file which has already been distributed to the rich client terminal 11, the management server 21 notifies the management module 201A or the agent 301A of the identifier of the virtual image file to be downloaded.

a2: The management module 201A or the agent 301A requests a virtual image file having the notified identifier from the virtual image creation and distribution server 24, and downloads the virtual image file from the virtual image creation and distribution server 24. Activating or re-activating the virtual machine 104 will start the OS (virtual OS) 301 in the downloaded virtual image file.

a3: The virtual OS 301 displays a log-on window. The user performs log-on operation on the log-on window. The virtual OS 301 performs user authentication in cooperation with the domain controller 23. If the user authentication succeeds, the virtual machine 104 (agent 301A) transmits a connection request to the connection broker 26 to inquire the connection broker 26 about the storage location of a user profile corresponding to the user who has performed the log-on operation. A connection request is a request for connecting (logging on) the rich client terminal 11 to the client management system 1, and contains the user account (user ID) of a user who has performed log-on operation. A user ID is an identifier for uniquely identifying the user. The connection broker 26 transmits, to the virtual machine 104, information indicating a path to a storage location in the profile storage 27 at which the user profile associated with the user ID of this user is stored, i.e., a storage path (agent 301A).

a4: The virtual machine 104 (agent 301A) mounts the storage location of the user profile in the profile storage 27 on the file system of the virtual machine 104 (virtual OS 301). Subsequently, the virtual machine 104 accesses the storage location of the user profile in the profile storage 27 instead of the local storage of the rich client terminal 11 to read or write the user profile.

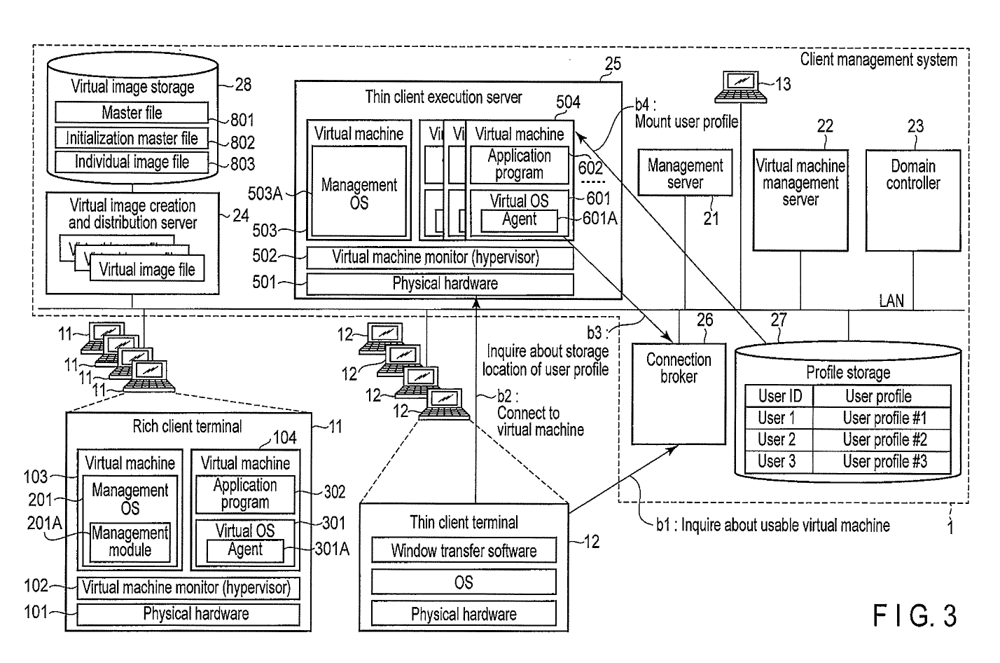

The operation sequence of the thin client terminal 12 will be described next with reference to FIG. 3.

b1: The OS 402 or window transfer software 403 of the thin client terminal 12 inquires the connection broker 26 about a usable virtual machine. The connection broker 26 sends, to the thin client terminal 12, information designating the virtual machine 504 on the thin client execution server 25, which can be used by the thin client terminal 12. In this case, the connection broker 26 may send, to the thin client terminal 12, a list of virtual machines 504 on the thin client execution server 25, which can be used by the thin client terminal 12. For example, based on the user ID contained in the inquiry, the connection broker 26 can send, to the thin client terminal 12, a window for displaying a list of virtual machines 504 which can implement a desktop environment corresponding to this user and which are not currently used. The user selects one virtual machine 504 from the displayed list of the virtual machines 504.

b2: The OS 402 or the window transfer software 403 is connected to the virtual machine 504 designated by the connection broker 26 or the virtual machine 504 selected from the list of the virtual machines 504, and activates the connected virtual machine 504. This will start the virtual OS 601 in the virtual machine 504.

b3: The virtual OS 601 displays a log-on window. The user performs log-on operation on the log-on window. The virtual OS 601 performs user authentication in cooperation with the domain controller 23. If the user authentication succeeds, the virtual machine 504 (agent 601A) transmits a connection request to the connection broker 26 to inquire the connection broker 26 about the storage location of a user profile corresponding to the user who has performed the log-on operation. The connection request is a request for connecting (logging on) the thin client terminal 12 to the client management system 1, and contains the user account (user ID) of the user who has performed the log-on operation. The connection broker 26 notifies the virtual machine 504 (agent 601A) of information indicating a path to the storage location in the profile storage 27 at which the user profile associated with the user ID of the user is stored, i.e., a storage path.

b4: The virtual machine 504 (agent 601A) automatically mounts the storage location of the user profile in the profile storage 27 on the file system of the virtual machine 504 (virtual OS 601). Subsequently, the virtual machine 504 accesses the storage location of the user profile in the profile storage 27 instead of the local storage of the thin client execution server 25 to read or write the user profile.

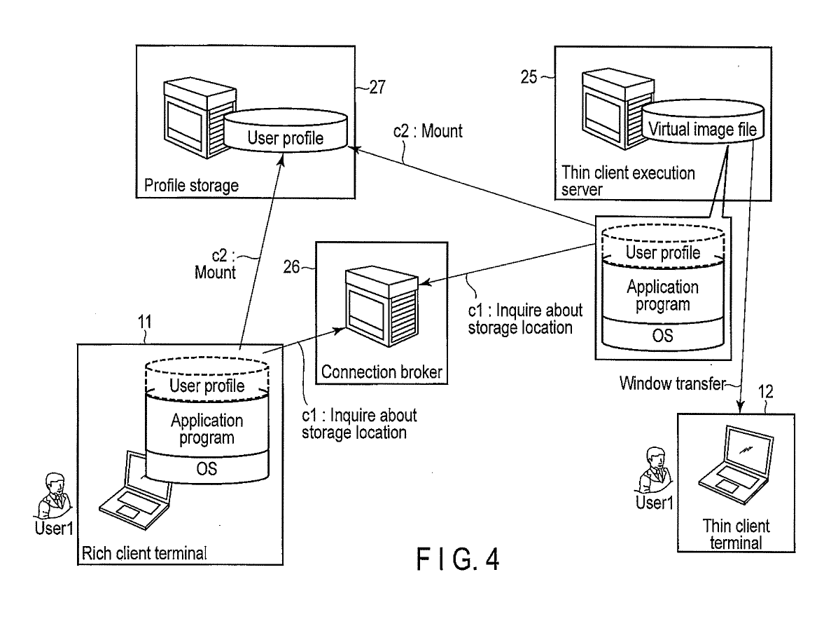

The roaming function executed by the connection broker 26 will be described next with reference to FIG. 4.

This roaming function is a function of allowing each user to use the same user profile corresponding to the user regardless of the rich client terminal 11 or the thin client terminal 12 used by the user.

Assume that the rich client terminals 11 are arranged on the desks of the respective users, and the thin client terminals 12 are arranged in a meeting room or a public space. Each user can log-on to the client management system 1 by operating the rich client terminal 11 on his/her desk. When the user moves to the meeting room or the public space, he/she can log-on to the client management system 1 by operating the thin client terminal 12. In this case, regardless of the client terminal used by each user, the roaming function provides the same user profile to a virtual machine corresponding to the client terminal.

The processing executed by the connection broker 26 when a user has performed log-on operation on the rich client terminal 11 will be described first.

c1: The user (User 1) performs log-on operation for connecting the rich client terminal 11 on his/her desk to the client management system 1. The virtual machine 104 of the rich client terminal 11, for example, the agent 301A, transmits a connection request to the connection broker 26 to inquire the connection broker 26 about the storage location of a user profile corresponding to the user (User 1) who has performed the log-on operation.

c2: The connection broker 26 transmits the storage path of the user profile of the user (User 1) to the virtual machine 104 of the rich client terminal 11. The virtual machine 104 mounts the user profile of the user (User 1) on the file system of the virtual machine 104. The file system of the virtual machine 104 is a file system managed by the virtual OS 301 in the virtual machine 104.

Each user profile in the profile storage 27 may be a virtual image file such as a virtual hard disk (VHD) format file. In this case, the virtual image file of the user profile is mounted at a predetermined mount point on the file system of the virtual machine 104. For example, a predetermined directory (user profile directory) in the file system for the storage of the user profile is used as the above mount point.

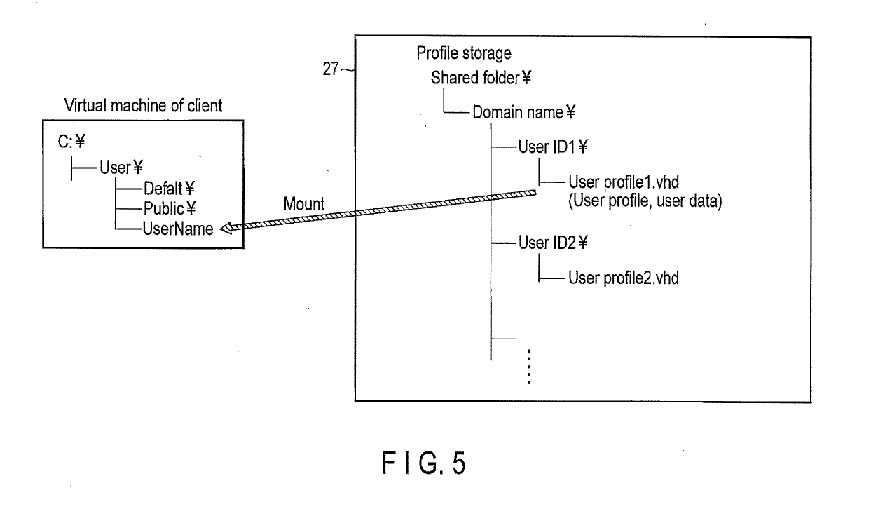

FIG. 5 shows this state. As shown in FIG. 5, a plurality of folders corresponding to a plurality of user IDs (user ID 1, user ID 2, . . . ) exist in the profile storage 27. These folders (user ID 1¥, user ID 2¥, . . . ) store user profiles (UserProfile1.vhd, UserProfile2.vhd, . . . ) respectively associated with the plurality of user IDs (user ID 1, user ID 2, . . . ). UserProfile1.vhd is mounted on the user profile directory (user ID 1) on the file system of the virtual machine 104.

The virtual OS 301 can read the user profile mounted on the file system from the profile storage 27 and perform, for example, setting of an application program and a desktop environment based on setting information in the user profile. User data such as various kinds of documents also exist in the user profile. The virtual OS 301 can read the user data in the user profile mounted on the file system from the profile storage 27 and display the user data on the display of the rich client terminal 11. In addition, updated user data, setting information, or the like is stored in the profile storage 27 instead of the local storage of the rich client terminal 11.

The processing executed by the connection broker 26 when the user has performed log-on operation on the thin client terminal 12 will be described next.

c1: The user (User 1) performs log-on operation for connecting the thin client terminal 12 placed in, for example, a public space to the client management system 1. The virtual machine 504 on a thin client execution server 45 corresponding to the thin client terminal 12, for example, the agent 601A, transmits a connection request to the connection broker 26 to inquire the connection broker 26 about the storage location of a user profile corresponding to the user (User 1) who has performed the log-on operation.

c2: The connection broker 26 transmits the storage path of the user profile of the user (User 1) to the virtual machine 504 on the thin client execution server 25 which corresponds to the thin client terminal 12. The virtual machine 504 mounts the user profile of the user (User 1) on the file system of the virtual machine 504. The file system of the virtual machine 504 is a file system managed by the virtual OS 601 in the virtual machine 504. The virtual OS 601 can read the user profile mounted on the file system from the profile storage 27 and perform, for example, setting of an application program and a desktop environment based on setting information in the user profile.

As described above, each user can use the same user environment regardless of the client terminal on which he/she performs log-on operation.

A large increase in the number of client terminals leads to the consumption of a large amount of storage area in the virtual image storage 28 which stores virtual image files. Even if the number of virtual image files to be managed by the client management system 1 greatly increases, the management server 21 executes management processing for virtual image files to minimize the required capacity of the virtual image storage 28.

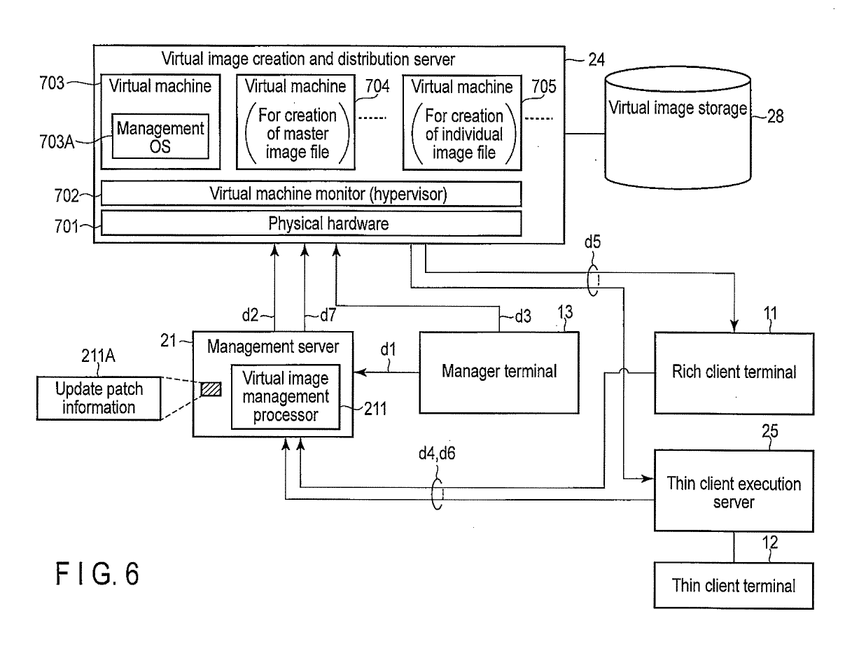

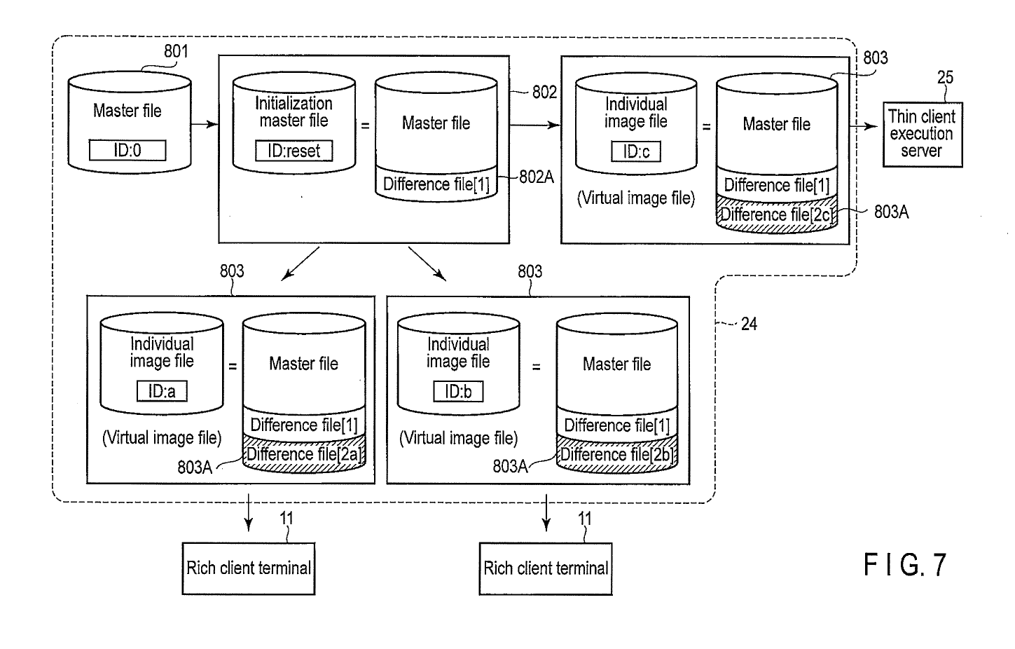

Virtual image file management processing executed by the management server 21 will be described with reference to FIG. 6 and FIG. 7. FIG. 6 is an exemplary block diagram for explaining a linkage for handling virtual image files in the client management system 1.

When creating a virtual image file for the rich client terminal 11 or thin client terminal 12, the manager terminal 13 notifies the management server 21 of a request to create a virtual image file (d1 in FIG. 6). Upon receiving this notification, the management server 21 notifies the virtual image creation and distribution server 24 of an instruction to create a requested virtual image file (d2 in FIG. 6). The management server 21 includes a virtual image management processor 211 which controls management processing for virtual image files. The management server 21 also manages update patch information 211A (to be described later).

As shown in FIG. 6, the virtual image creation and distribution server 24 executes a virtual machine monitor 702 on physical hardware 701 such as a CPU, memory, storage, and various kinds of I/O devices. The virtual machine monitor 702 is virtualization software such as a hypervisor, which functions as a virtualization layer on the physical hardware 701 by emulating the resources of the physical hardware 101. On the virtual machine monitor 702, one virtual machine 703 for management and a plurality of virtual machines 704 and 705 for creating a virtual image file are executed. The virtual machine 703 executes a management OS (host OS) 703A. In contrast, the virtual machines 704 and 705 execute creation processing for a virtual image file instructed from the management server 21.

Upon receiving the instruction to create a virtual image file from the management server 21, the virtual image creation and distribution server 24 returns information indicating the virtual machines 704 and 705 to be used for the creation of this virtual image file to the management server 21. The management server 21 transfers the information designating the virtual machines 704 and 705 on the virtual image creation and distribution server 24 (as a response to the virtual image file creation request) to the manager terminal 13. The manager terminal 13 is connected to the virtual machines 704 and 705 designated by the management server 21 and activates the connected virtual machines 704 and 705 (d3 in FIG. 6). This allows the user (manager) to make the virtual image creation and distribution server 24 create a virtual image file by operating the manager terminal 13. The virtual image storage 28 stores the virtual image file created by the virtual image creation and distribution server 24.

FIG. 7 is an exemplary view for explaining the structure of the virtual image files created by the virtual image creation and distribution server 24.

As described above, the virtual image file includes the master file 801, the initialization master file 802 as a difference file, and the individual image file 803. The determination condition 704 on the virtual image creation and distribution server 24 shown in FIG. 6 is a virtual machine for creating the master file 801 and the initialization master file 802. The virtual machine 705 is a virtual machine for creating the individual image file 803.

When creating a virtual image file for the rich client terminal 11, the virtual image creation and distribution server 24 executes the installation of the virtual OS 301 and application program 302 on the virtual machine 704, and creates an image file (disk image file) of a disk in which the virtual OS 301 and the application program 302 are installed. When creating a virtual image file for the thin client terminal 12, the virtual image creation and distribution server 24 executes the installation of the virtual OS 601 and application program 602 on the virtual machine 704, and creates an image file (disk image file) of a disk in which the virtual OS 601 and the application program 602 are installed. At the time of this installation, machine unique information (ID: 0) is tentatively input and included in a disk image file to be created. The master file 801 is a disk image file containing this tentatively input machine unique information (ID: 0).

When the master file 801 is created, the machine unique information (ID: 0) contained in the master file 801 is reset on the virtual machine 704. The initialization master file 802 is a disk image file in which machine unique information is reset (ID: reset). The entity of the initialization master file 802 is the one obtained by adding a difference file 802A to the master file 801. Therefore, the processing of resetting the machine unique information (ID: 0) contained in the master file 801 amounts to the processing of creating the difference file 802A.

On the virtual machine 705, the machine unique information (ID: a, b, c, . . . ) of the rich client terminal 11 or thin client terminal 12 is set in the initialization master file 802. The disk image file created by this processing is the individual image file 803. The entity of the initialization master file 802 is the one obtained by adding a difference file 803A to the initialization master file 802, i.e., the one obtained by adding the difference file 802A and the difference file 803A to the master file 801. Therefore, the processing of setting the machine unique information (ID: a, b, c, . . . ) of the rich client terminal 11 or thin client terminal 12 in the initialization master file 802 amounts to the processing of creating the difference file 803A. The difference files 803A equal in number to virtual image files exist. As the number of rich client terminals 11 increases, therefore, the number of difference files 803A increases.

As is obvious from the above description, the virtual image storage 28 stores the master file 801, the difference file 802A (for forming the initialization master file 802 based on the master file 801), and the difference file 803A (for forming the individual image file 803 based on the initialization master file 802). The virtual image creation and distribution server 24 distributes the master file 801, the difference file 802A, and the difference file 803A as a virtual image file to the rich client terminal 11 or the thin client execution server 25.

Refer back to FIG. 6.

The rich client terminal 11 or the thin client execution server 25 inquires the management server 21 about whether there is any virtual image file to be downloaded from the virtual image creation and distribution server 24 (d4 in FIG. 6). If there is a virtual image file to be downloaded and its identifier is notified from the management server 21, the rich client terminal 11 or the thin client execution server 25 requests a virtual image file having the notified identifier from the virtual image creation and distribution server 24 and downloads the virtual image file from the virtual image creation and distribution server 24 (d5 in FIG. 6).

Upon completion of downloading of the virtual image file from the virtual image creation and distribution server 24, the rich client terminal 11 or the thin client execution server 25 notifies the management server 21 of the corresponding information (d6 in FIG. 6). Upon receiving this notification, the management server 21 notifies the virtual image creation and distribution server 24 of an instruction to delete the difference file 803A for the virtual image file which has been completely downloaded (d7 in FIG. 6). The virtual image creation and distribution server 24 deletes, from the virtual image storage 28, the difference file 803A for which it has received the deletion instruction from the management server 21.

In the client management system 1 of this embodiment, as described above, the management server 21 performs control to delete, from the virtual image storage 28, the difference file 803A for the virtual image file which has been completely acquired from the virtual image creation and distribution server 24 by the rich client terminal 11 or the thin client execution server 25. This prevents the consumed capacity of the virtual image storage 28 from linearly increasing with an increase in the number of client terminals. Even at an event in which a virtual image file must be supplied again, since the initialization master file 802 constituted by the master file 801 and the difference file 802A exists in the virtual image storage 28, it is easy to recover the difference file 803A. That is, the management server 21 implements efficient management of the desktop environments (virtual image files) of client terminals.

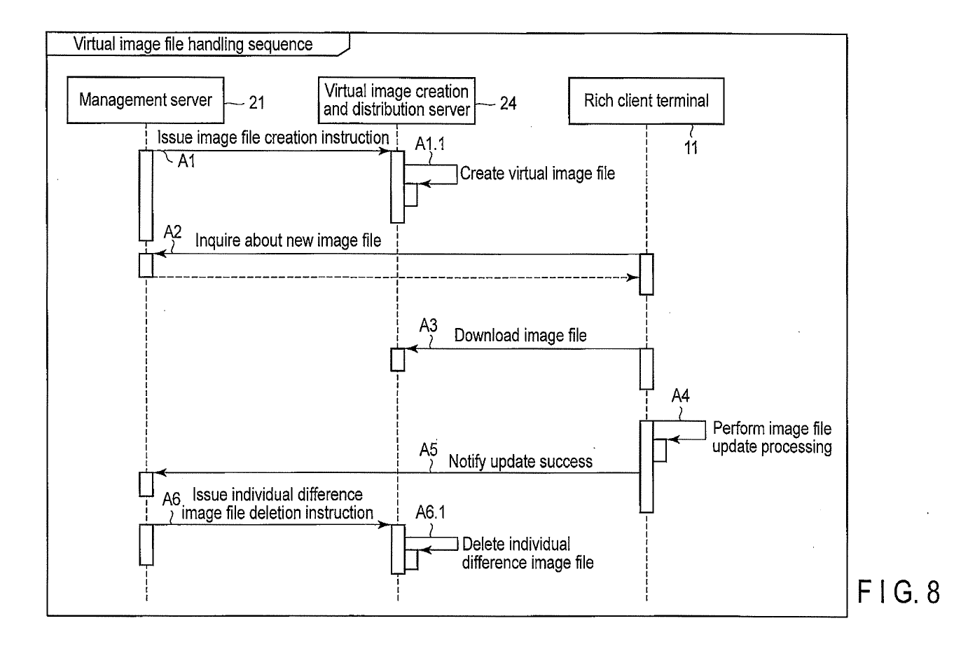

FIG. 8 is an exemplary sequence chart associated with the handling of a virtual image file.

The management server 21 notifies the virtual image creation and distribution server 24 of an instruction to create a virtual image file (step A1). Upon receiving this notification, the virtual image creation and distribution server 24 executes virtual image file creation processing (step A1.1). The virtual image storage 28 stores the created virtual image file.

The rich client terminal 11 inquires the management server 21 about whether there is any new virtual image file (step A2). Based on a reply from the management server 21, the rich client terminal 11 downloads the new virtual image file from the virtual image creation and distribution server 24 (step A3). The rich client terminal 11 executes update processing for the virtual image file (step A4), and notifies the management server 21 of an update success (step A5).

Upon receiving the notification of the update success of the virtual image file from the rich client terminal 11, the management server 21 notifies the virtual image creation and distribution server 24 of an instruction to delete the individual image file (difference file) for the rich client terminal 11 (step A6). Upon receiving this notification, the virtual image creation and distribution server 24 executes the processing of deleting the individual image file (difference file) for the rich client terminal 11 for which the instruction has been issued (stored in the virtual image storage 28) (step A6.1).

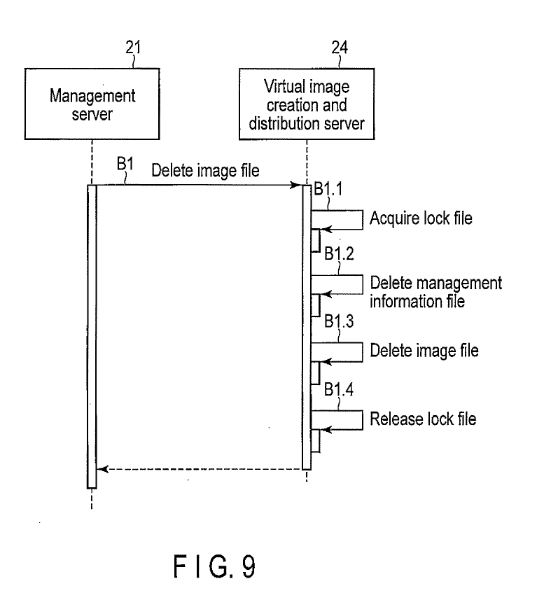

FIG. 9 is an exemplary view showing a sequence of deletion processing of a virtual image file including the individual image file 803 (difference file 803A).

The management server 21 instructs the virtual image creation and distribution server 24 to delete the virtual image file (step B1). Upon receiving this instruction, the virtual image creation and distribution server 24 locks the virtual image file to be deleted (step B1.1). First of all, the virtual image creation and distribution server 24 deletes the management information file of the virtual image file to be deleted (step B1.2). The virtual image creation and distribution server 24 then executes the deletion of the virtual image file to be deleted (step B1.3).

The virtual image creation and distribution server 24 releases the lock (step B1.4), and notifies the management server 21 of the completion of the deletion of the virtual image file.

Consider a case in which when the number of rich client terminals 11 increases, the number of virtual image creation and distribution servers 24 is increased to perform decentralized management of virtual image files. In such a case, the management server 21 properly executes decentralized management of virtual image files.

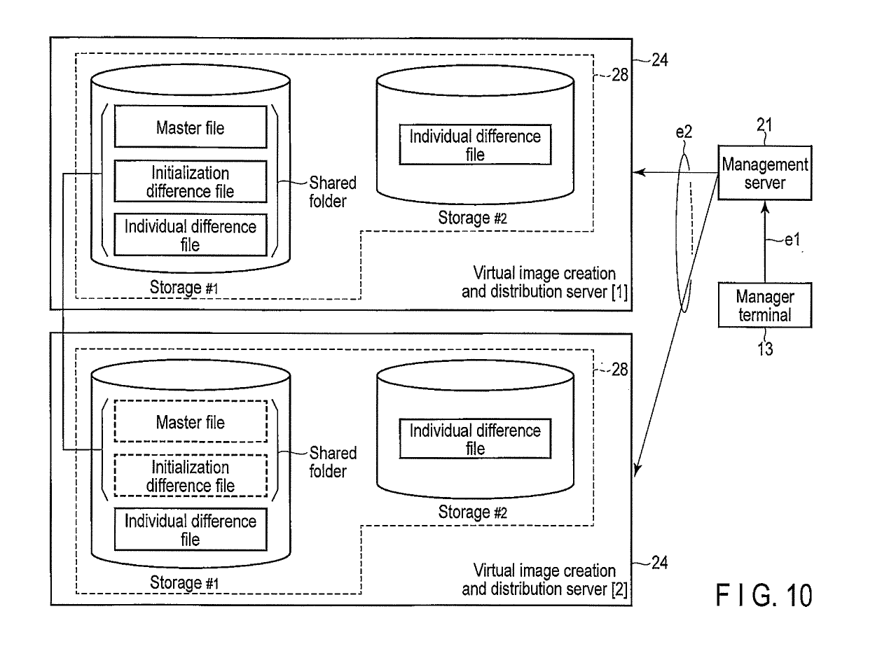

FIG. 10 is an exemplary view showing one form of decentralized management of virtual image files which is performed by the two virtual image creation and distribution servers 24.

Assume that a virtual image creation and distribution server [1] 24 and a virtual image creation and distribution server [2] 24 perform decentralized management of virtual image files, as shown in FIG. 10. Assume also that the virtual image creation and distribution server [1] 24 serves as a master, and the virtual image creation and distribution server [2] 24 serves as a slave.

In this case, of the three files constituting the virtual image file, namely the master file 801, the initialization master file 802 (difference file 802A), and the individual image file 803 (difference file 803A), the two files, namely the master file 801 and the initialization master file 802 (difference file 802A) are stored in the virtual image storage 28 on the virtual image creation and distribution server [1] 24 side. In other words, the virtual image creation and distribution server [1] 24 executes creation processing for the master file 801 and the initialization master file 802 (difference file 802A).

Therefore, only the individual image file 803 (difference file 803A) is assigned to the virtual image creation and distribution server [1] 24 or the virtual image creation and distribution server [2] 24 and stored in the corresponding virtual image storage 28. The folder in the virtual image storage 28 on the virtual image creation and distribution server [1] 24 side in which the master file 801 and the initialization master file 802 (difference file 802A) are stored is set as a shared folder which can be accessed from the virtual image creation and distribution server [2] 24. The virtual image creation and distribution server [2] 24 reads the master file 801 and the initialization master file 802 (difference file 802A) from this shared folder as necessary.

Upon receiving, for example, an instruction to create a virtual image file for a given rich client terminal 11 from the manager terminal 13 (e1 in FIG. 10), the management server 21 decides one of the virtual image creation and distribution server [1] 24 and the virtual image creation and distribution server [2] 24 to which the individual image file 803 (difference file 803A) for the formation of this virtual image file should be assigned, and instructs the virtual image creation and distribution server 24 decided as an assignment destination to create a virtual image file for the rich client terminal 11 (e2 in FIG. 10).

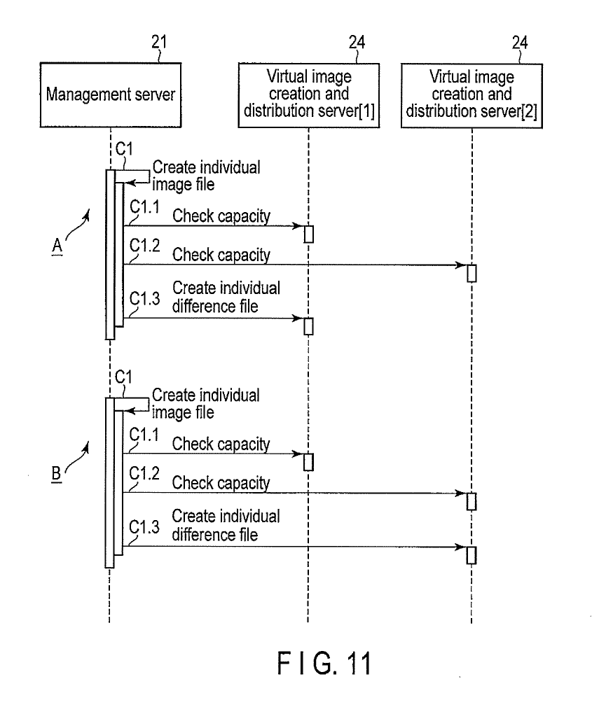

FIG. 11 is an exemplary view for explaining the first principle based on which the management server 21 decides the assignment destinations of virtual image files.

Upon starting individual image file creation processing (step C1), the management server 21 instructs the virtual image creation and distribution server 24 to check free spaces (steps C1.1 and C1.2). The management server 21 selects the largest one of the free spaces returned from the virtual image creation and distribution servers 24, and instructs the virtual image creation and distribution server 24 which has returned the selected free space to create an individual image file (step C1.3). That is, the management server 21 assigns a virtual image file to one of the virtual image creation and distribution servers 24 which has the largest free space in each operation.

Referring to FIG. 11, “A” indicates a sequence for a case in which the virtual image creation and distribution server [1] 24 has a larger free space, and “B” indicates a sequence for a case in which the virtual image creation and distribution server [2] 24 has a larger free space.

Consider a case in which virtual image files are collectively created, for example, for each section such as division or department. That is, consider a case in which a plurality of virtual image files are collectively created.

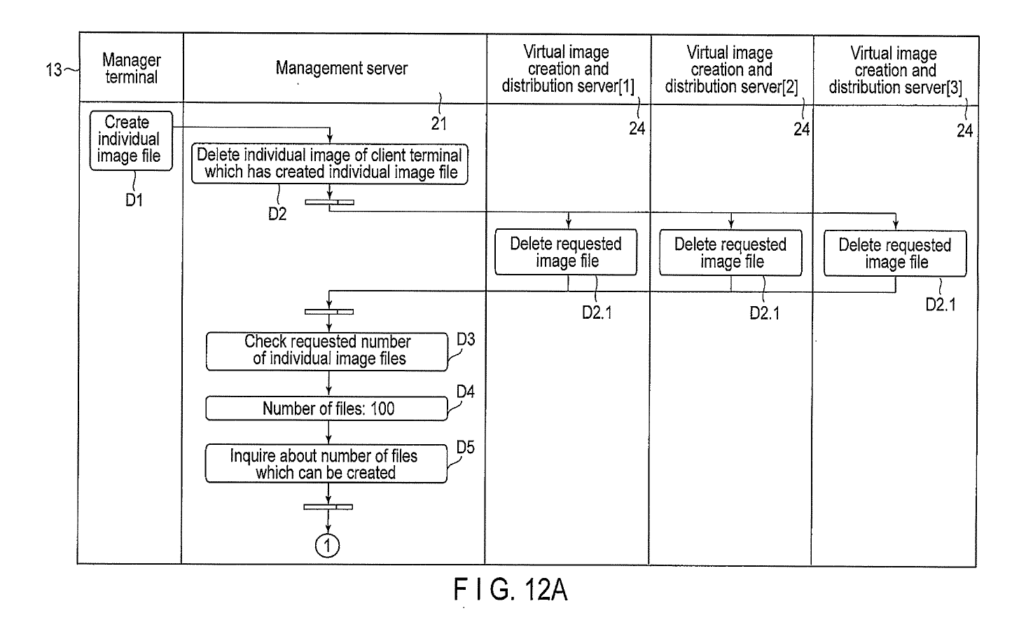

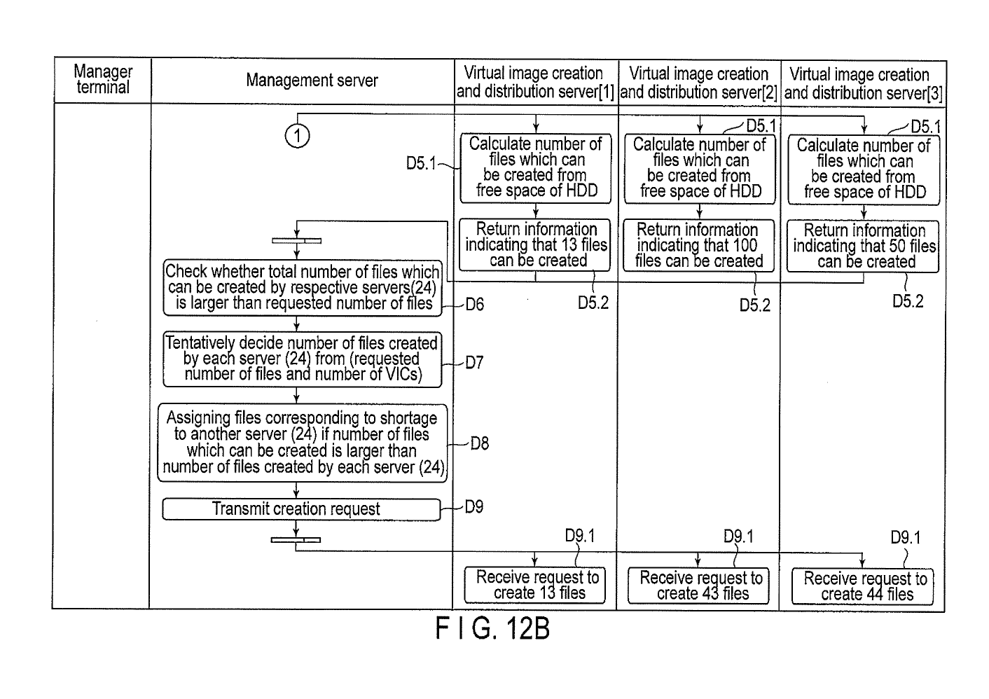

FIG. 12A and FIG. 12B are exemplary views for explaining the second principle based on which the management server 21 decides the assignment destinations of virtual image files. FIG. 12A and FIG. 12B show a state in which a virtual image creation and distribution server [3] 24 is added. Assume that individual image files are created for a plurality of rich client terminals 11 (for example, 100 terminals).

When the manager performs operation for creating an individual image file by using the manager terminal 13 (step D1), the management server 21 executes first the processing of deleting a remaining individual image file before updating (which, for example, has not been downloaded or has failed to be deleted) (step D2). More specifically, the management server 21 instructs the virtual image creation and distribution server 24 storing the target individual image file in the virtual image storage 28 to delete the individual image file (step D2.1).

Upon checking the requested number of individual image files created (step D3) and calculating the number (step D4), the management server 21 inquires the virtual image creation and distribution server 24 about the number of individual image files which can be created (step D5). Upon receiving this inquiry, the virtual image creation and distribution server 24 calculates the number of individual image files which can be created from the free space of the virtual image storage 28 at this time (step D5.1), and returns the calculation result to the management server 21 (step D5.2).

The management server 21 confirms that the total number of individual image files which can be created, returned from the respective virtual image creation and distribution servers 24, is larger than the requested number of individual image files created (step D6), and tentatively decides the value (quotient) obtained by dividing the requested number of individual image files created by the number of virtual image creation and distribution servers 24 as the number of individual image files to be assigned to the respective virtual image creation and distribution servers 24 (step D7). After this tentative decision, the management server 21 performs adjustment, for example, assigning individual image files corresponding to the shortage of the virtual image creation and distribution server 24, in terms of the number of individual image files which can be created relative to the number of individual image files assigned, to another virtual image creation and distribution server 24 (step D8). The management server 21 then instructs each virtual image creation and distribution server 24 to create individual image files by the finally decided number (step D9). Upon receiving this instruction (step D9.1), each virtual image creation and distribution server 24 creates the designated number of individual image files.

That is, the management server 21 executes assignment of individual image files to the respective virtual image creation and distribution servers 24 in accordance with free spaces at different times.

For an OS or application program, a program (update patch) for the correction of bugs is sometimes provided at random times. In order to apply such update patches, a virtual image file is updated, for example, for every month. That is, it is a general practice that update patches provided over one month are accumulated and are collectively reflected in a virtual image file at the time of an update.

In such an operation, update patches are reflected in a virtual image file with a delay of one month at maximum. For this reason, the management server 21 determines the presence/absence of an update patch in update processing of a virtual image file, for example, for each day, and, if there is an update patch, performs control to execute update processing of the (corresponding) virtual image file. The update patch information 211A shown in FIG. 6 is information indicating the presence/absence of an update patch. An update patch itself is stored, for example, in storage in a file server (not shown) in the client management system 1.

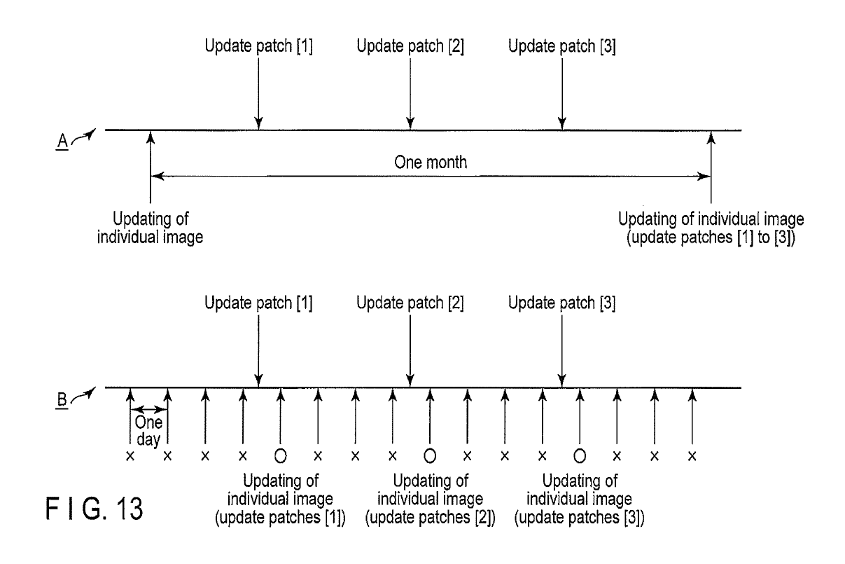

FIG. 13 is an exemplary view for explaining operation associated with the updating of a virtual image file.

Referring to FIG. 13, “A” indicates the above operation of collectively reflecting update patches accumulated, for example, over one month, in a virtual image file for every month. In contrast, “B” indicates the operation of executing update processing of a virtual image file under the control of the management server 21 if there is an update patch.

As is obvious from FIG. 13, the operation indicated by “B” allows to timely reflect an update patch in a virtual image file. Even executing update processing of a virtual image file every day can prevent unnecessary update processing from being executed if there is no update patch. That is, the management server 21 properly executes management of virtual image files.

Note that it is possible to implement operation control processing of each embodiment by software (programs). It is possible to easily obtain the same effects as those of each embodiment by installing and executing this software in a computer via a computer readable storage medium storing the software.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus applied to a client management system which manages desktop environments of a plurality of client terminals, the apparatus comprising:
a first controller configured to control creation processing for first image files and difference files, the first image files being disk image files for the desktop environments and containing no information unique to the plurality of client terminals, the difference files being files for formation of second image files respectively containing information unique to the plurality of client terminals based on the first image files; and
a second controller configured to control deletion processing for the difference file for which the second image file is completely acquired by a corresponding client terminal of the plurality of client terminals.

2. The apparatus of claim 1, wherein the first controller is configured to perform control to store the difference files at a location with the largest free space when the difference files are managed in a decentralized manner.

3. The apparatus of claim 1, wherein the first controller is configured to perform control to assign and store the difference files in accordance with free spaces at the respective locations when the difference files are managed in a decentralized manner.

4. The apparatus of claim 1, wherein the first controller is configured to determine the presence/absence of an update for the first image file, and to control update processing for the second image file so as to re-create the difference file for forming the second image file again in which the update is reflected if the update is present.

5. An image file management method for an information processing apparatus applied to a client management system which manages desktop environments of a plurality of client terminals, the method comprising:
controlling creation processing for first image files and difference files, the first image files being disk image files for the desktop environments and containing no information unique to the plurality of client terminals, the difference files being files for formation of second image files respectively containing information unique to the plurality of client terminals based on the first image files; and
controlling deletion processing for the difference file for which the second image file is completely acquired by a corresponding client terminal of the plurality of client terminals.

6. The method of claim 5, wherein the controlling creation processing for the difference files comprises performing control to store the difference files at a location with the largest free space when the difference files are managed in a decentralized manner.

7. The method of claim 5, wherein the controlling creation processing for the difference files comprises performing control to assign and store the difference files in accordance with free spaces at the respective locations when the difference files are managed in a decentralized manner.

8. The method of claim 5, wherein the controlling creation processing for the difference files comprises determining the presence/absence of an update for the first image file, and controlling update processing for the second image file so as to re-create the difference file for forming the second image file again in which the update is reflected if the update is present.

9. A computer-readable, non-transitory storage medium having stored thereon a computer program which is executable by a computer which is applied to a client management system which manages desktop environments of a plurality of client terminals, the computer program controlling the computer to function as:
a first controller configured to control creation processing for first image files and difference files, the first image files being disk image files for the desktop environments and containing no information unique to the plurality of client terminals, the difference files being files for formation of second image files respectively containing information unique to the plurality of client terminals based on the first image files; and
a second controller configured to control deletion processing for the difference file for which the second image file is completely acquired by a corresponding client terminal of the plurality of client terminals.

10. The medium of claim 9, wherein the first controller is configured to perform control to store the difference files at a location with the largest free space when the difference files are managed in a decentralized manner.

11. The medium of claim 9, wherein the first controller is configured to perform control to assign and store the difference files in accordance with free spaces at the respective locations when the difference files are managed in a decentralized manner.

12. The medium of claim 9, wherein the first controller is configured to determine the presence/absence of an update for the first image file, and to control update processing for the second image file so as to re-create the difference file for forming the second image file again in which the update is reflected if the update is present.
